(19) United States
(12) Patent Application Publication
(10) Pub. No.: US 2023/0237153 A1
(43) Pub. Date: Jul. 27, 2023

(54) BASIC INPUT/OUTPUT SYSTEM (BIOS) ACTIVATION CONTROL OF MEDIA CAPTURE DEVICES

(71) Applicant: Hewlett-Packard Development Company, L.P., Spring, TX (US)

(72) Inventors: YI-FAN HSIA, TAIPEI CITY (TW); CHIH-KAI CHANG, TAIPEI CITY (TW); HUNG-LUNG CHEN, TAIPEI CITY (TW); CHIA-CHENG LIN, TAIPEI CITY (TW); HSIN-JEN LIN, TAIPEI CITY (TW); HENG-FU CHANG, TAIPEI CITY (TW)

(73) Assignee: Hewlett-Packard Development Company, L.P., Spring, TX (US)

(21) Appl. No.: 18/001,231

(22) PCT Filed: Jul. 22, 2020
(86) PCT No.: PCT/US20/43044

§ 371 Date: Dec. 8, 2022

(51) Int. Cl. G06F 21/57; G06F 21/44

(52) U.S. Cl. CPC G06F 21/57; G06F 21/44

(57) ABSTRACT

An example computing device comprises: a media capture device to capture media; a pin coupled to the media capture device to communicate an unlock signal to the media capture device; and a basic input/output system interconnected with the pin, wherein, to control activation of the media capture device, the basic input/output system is to: store an authentication parameter, receive, from the media capture device, an unlock request; in response to the unlock request, verify an authentication input against the authentication parameter, and in response to a successful verification, send the unlock signal to unlock the media capture device via the pin.

### BACKGROUND

Personal computing devices may include media capture devices to capture media, such as images, videos, and audio inputs. For example, webcams and microphones may allow users to capture image data and audio data, respectively.

### BRIEF DESCRIPTION OF THE DRAWINGS

FIG. 1 is a block diagram of an example computing device with basic input/output system activation control of a media capture device.

FIG. 2 is a block diagram of another example computing device with basic input/output system activation control of a media capture device.

FIG. 3 is a block diagram of a machine-readable storage medium in the computing device of FIG. 2 storing instructions for managing a media capture device.

FIG. 4A is a flowchart of an example method of processing a media capture device activation request in a media capture device.

FIG. 4B is a flowchart of an example method of processing a media capture device activation request in a processor.

FIG. 5 is a flowchart of an example method of basic input/output system activation control of a media capture device.

FIG. 6 is a flowchart of an example method of polling during activation of a media capture device.

FIG. 7 is a flowchart of an example method of processing a lock request.

### DETAILED DESCRIPTION

Personal computing devices often include media capture devices to capture media, such as images, videos, and audio inputs. Applications executable on the computing devices may utilize the media capture devices, for example to enable video conferencing, or otherwise to support the application. Personal computing devices may also be vulnerable to attack from malware which activates the media capture devices and enables, for example, unauthorized capture of images or videos by a camera. Some computing devices may include indicators to indicate that the camera is in use, however, such warning indicators may be tampered with if an attacker is able to control the operating system (OS) of the computing device.

An example computing device, as presently described, provides a computing device with a basic input/output system (BIOS) activation control for media capture devices, such as cameras. The computing device includes a media capture device, a pin, and a BIOS storing an authentication parameter. When access to the media capture device is requested, the media capture device sends an unlock request to the BIOS. The BIOS verifies an authentication input against the authentication parameter. For example, the BIOS may prompt a user to enter an authentication input, such as a password or a biometric. Upon successful verification, the BIOS unlocks the media capture device via the pin, for example, by enabling power to the media capture device via the pin. By using the BIOS to authenticate, the media capture device may be less vulnerable to attacks. In particular, generation of the unlock request by the media capture device itself (i.e., via firmware), allows for robust cross-platform implementation of BIOS-based activation control. In further examples, BIOS activation control may be combined with preliminary authentication, multi-layered activation, and periodic polling to securely manage the media capture device.

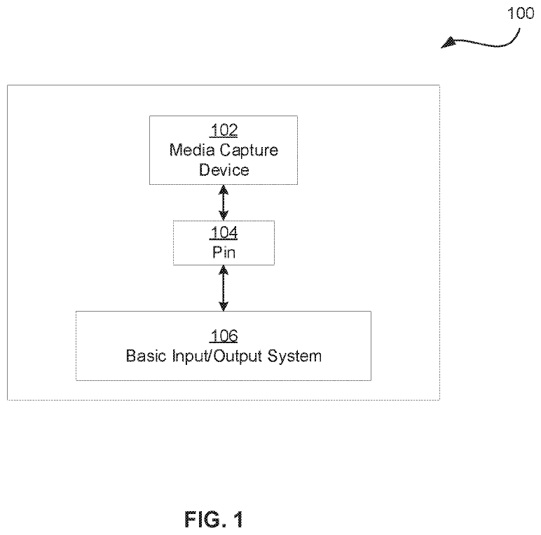

FIG. 1 shows a block diagram of an example computing device 100. The computing device 100 may be, for example, a personal computing device, such as a laptop, a desktop computer, or the like. The computing device 100 includes a media capture device 102, a pin 104, and a basic input/output system (BIOS) 106.

The media capture device 102 may be disposed, for example, in a housing of the computing device 100 and is to capture media. For example, the media capture device 102 may include a camera, such as visible light camera, an infrared light camera, or the like, to capture image data, including images and videos. In other examples, the media capture device 102 may be a microphone or the like to capture audio data. The media capture device 102 further includes firmware to cooperate with the BIOS 106 to securely lock and unlock the media capture device 102, as described below.

The pin 104 is coupled to the media capture device 102 to communicate an unlock signal to the media capture device 102 to lock and unlock the media capture device 102. For example, the pin 104 may be a general-purpose input/output (GPIO) pin of an embedded controller (EC) or a platform controller hub (PCH) coupled to the media capture device 102. In an example, the pin 104 may be to communicate power to the media capture device 102 to act as the unlock signal to unlock the media capture device 102.

As used herein, a basic input/output system (BIOS) refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

The BIOS 106 is interconnected with the pin 104 to manage the media capture device 102. In particular, the BIOS 106 is to authenticate an input prior to unlocking the media capture device 102 via the pin 104. Accordingly, the BIOS 106 stores an authentication parameter, for example as a variable in the BIOS 106 for verification of the authentication input.

In operation, the media capture device 102 may first detect or receive an access request to access or utilize the media capture device 102. The access request may be received, for example, from an application being executed in the computing device 100, from a switch to turn the media capture device 102 on and off, or the like. In response to the access request, the media capture device 102 (via execution of the firmware embedded therein) generates and sends an unlock request to the BIOS 106. The BIOS 106, in turn, receives the unlock request, and in response to the unlock request, verifies an authentication input against the authentication parameter stored in the BIOS 106. For example, the BIOS 106 may request the authentication input in response to the unlock request, or the unlock request itself may include the authentication input for verification. In response to a successful verification, the BIOS 106 sends the unlock signal (e.g., by enabling power) to unlock the media capture device 102 via the pin 104.

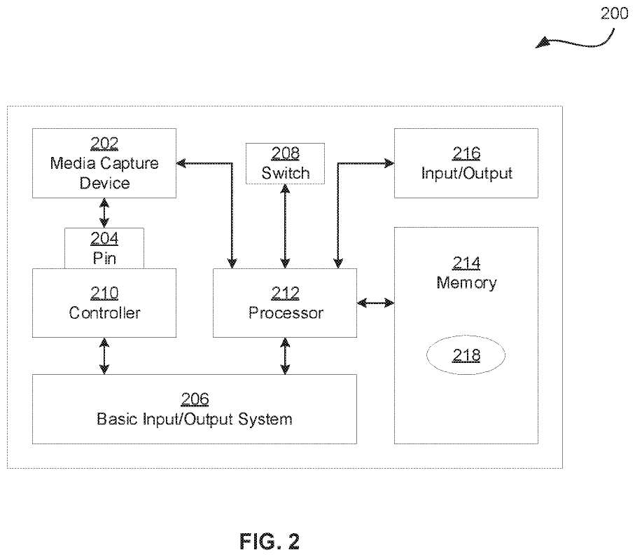

FIG. 2 depicts a block diagram of another example computing device 200. The computing device 200 is similar to the computing device 100, and may be a personal computing device such as a laptop, a desktop computer, or the like. The computing device 200 includes a media capture device 202, a pin 204, and a BIOS 206. The computing device 200 further includes a switch 208, a controller 210, a processor 212, a memory 214, and an input/output device 216.

The media capture device 202 is similar to the media capture device 102, and may include, for example, a camera to capture image data. In particular, the media capture device 202 is securely activated, in which the media capture device 202 is permitted to capture media, and deactivated, in which the media capture device 202 is prevented from capturing media.

The computing device 200 further includes the switch 208, which is interconnected with the processor 212. The switch 208 may be a physical switch disposed, for example, in a housing of the computing device 200 and operable by a user of the computing device 200. In particular, the switch 208 is switchable between an on position and an off position.

The controller 210 may be an embedded controller or a platform controller hub coupled to the media capture device 202 to control access to the media capture device 202. In particular, the controller 210 includes the pin 204 to communicate unlock signals to the media capture device 202. The pin 204 may be, for example, a GPIO pin of the controller 210. The pin 204 is coupled to the media capture device 202 to communicate an unlock signal to the media capture device 202 to unlock and lock the media capture device 202. For example, the pin 204 may be to communicate power to the media capture device 202 to act as the unlock signal to unlock the media capture device 202. In other examples, the controller 210 may include a first GPIO pin 204 to communicate power to the media capture device 202, and a second GPIO pin 204 to communicate an unlock signal to the media capture device 202.

The BIOS 206 is similar to the BIOS 106 and is interconnected with the controller 210 to manage the media capture device 202. In response to receiving an unlock request, the BIOS 206 verifies an authentication input prior to unlocking the media capture device 202 to ensure that the media capture device activation is secure.

The processor 212 is interconnected with the media capture device 202 and the BIOS 206. The processor 212 may include a central processing unit (CPU), a microcontroller, a microprocessor, a processing core, or similar device capable of executing instructions.

The processor 212 is also interconnected with a non-transitory machine-readable storage medium, such as the memory 214 that may be electronic, magnetic, optical, or other physical storage device that stores executable instructions. In particular, the memory 214 includes a media capture device management application 218 (also referred to herein as simply application 218). The application 218 includes machine-readable instructions executable by the processor 212 to cause the processor 212 to initiate and provide additional management of the media capture device 202. It will be understood that the processor 212 performing certain actions is so enabled by execution of the instructions defined in the application 218 by the processor 212.

The computing device 200 may further include the input/output device 216. The input/output device 216 can include input devices such as buttons, keypads, fingerprint sensors, touch-sensitive display screens or the like for receiving input from an operator. The input/output device 216 can include output devices such as display screens, speakers, vibrators, or the like for providing output or feedback to an operator.

The components of the computing device 200 cooperate to securely activate and deactivate the media capture device 202 to prevent unauthorized activation of the media capture device 202. In operation, media capture device activation requests may be generated by applications executed at the computing device (e.g., a video-conferencing application, or the like) or the switch 208 to activate the media capture device 202 (i.e., to allow the media capture device 202 to capture media). For example, when the switch 208 is moved to the on position, a media capture device activation request may be generated by the processor 212. Media capture device activation requests may be processed by the media capture device 202 itself, by the processor 212, via execution of the application 218, or both.

In particular, in some examples, the media capture device activation requests may be received and processed at the media capture device 202 as access requests. Accordingly, the media capture device 202 may further include firmware to allow the media capture device 202 to process the access requests and to cooperate with the BIOS 206 to securely activate and de-activate the media capture device 202. That is, in response to an access request, the media capture device 202 may send an unlock request to the BIOS 206 to request unlocking of the media capture device 202.

In other examples, the media capture device activation requests may be received and processed at the processor 212, via execution of the application 218, as initiation requests. Accordingly, the application 218 may provide instructions which allow the processor 212 to process initiation requests received from other applications or from the switch 208 requesting activation of the media capture device 202.

In some examples, the processor 212 may act as a bridge to process media capture device activation requests. That is, in response to an initiation request, the processor 212 may generate an access request to be sent to the media capture device 202. In other examples, the processor 212 may generate an unlock request to be sent to the BIOS 206 directly.

The BIOS 206 is therefore to receive unlock requests from the media capture device 202 or the processor 212. In particular, the unlock requests are requests to unlock the media capture device 202, for example, by providing power to the media capture device 202 via the pin 204. To provide secure activation of the media capture device 202, the BIOS 206 is to verify an authentication input prior to unlocking the media capture device 202.

In some examples, unlocking the media capture device 202 by the BIOS 206 is sufficient to activate the media capture device 202. In such examples, when initiation requests are received at the processor 212, the processor 212 may send access requests to the media capture device 202, since no further initialization is performed by the processor 212. In other examples, activation of the media capture device 202 is a two-step process, involving both unlocking the media capture device 202 by the BIOS 206 (e.g., by providing power to the media capture device 202 via the pin 204) and initiation of the media capture device 202 by the processor 212 in a software-level initialization process (e.g., by controlling an operating system device manager to initialize the media capture device 202).

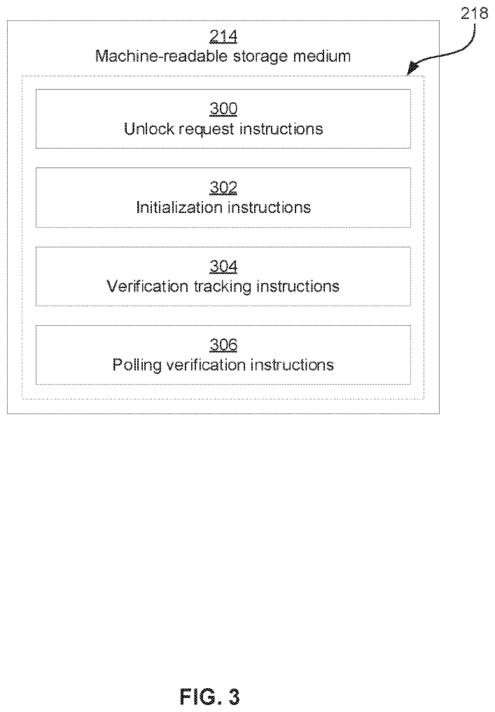

FIG. 3 depicts the memory 214 storing unlock request instructions 300, initiation instructions 302, verification tracking instructions 304, and polling verification instructions 306. The instructions 300, 302, 304, and 306 may, for example, form the application 218. The instructions 300, 302, 304, and 306 are described in conjunction with their execution by the processor 212; in other examples, they may be executed by another suitable controller or processor.

The unlock request instructions 300, when executed, cause the processor 212 to, in response to receiving an initiation request to initiate the media capture device 202, send an unlock request to the BIOS 206. For example, the initiation request via the operating system when another application requests access to the media capture device 202. In some examples, the unlock request instructions 300 may further cause the processor 212 to verify a preliminary authentication input prior to sending the unlock request. In particular, in response to a successful preliminary authentication, the processor 212 may send the unlock request to the BIOS 206. In some examples, the unlock request instructions 300 may further cause the processor 212 to include, with the unlock request, an authentication input. The authentication input may be sent, with the unlock request, to the BIOS 206 for the BIOS 206 to verify prior to unlocking the media capture device 202.

The initialization instructions 302, when executed, cause the processor 212 to, in response to a successful authentication of the unlock request by the BIOS 206, control an operating system device manager to initialize the media capture device 202 to allow the media capture device 202 to capture media. For example, the processor 212 may receive a response to the unlock request indicating a successful authentication and may subsequently initialize the media capture device 202.

The verification tracking instructions 304, when executed, cause the processor 212 to, when the media capture device is activated (i.e., in an active state capturing media) track a time since a most recent verification. The most recent verification time may be stored, for example, in a cache or in the memory 214. For example, upon receiving an indication of the successful authentication, a timestamp associated with said authentication may be stored as the most recent verification time.

The polling verification instructions 306, when executed, cause the processor 212 to after a predefined time since the most recent verification, verify a polling input to maintain the media capture device 202 activated. For example, the processor 212 may obtain a polling input, verify the polling input against a polling parameter, and in response to a successful polling verification, maintain the media capture device 202 activated.

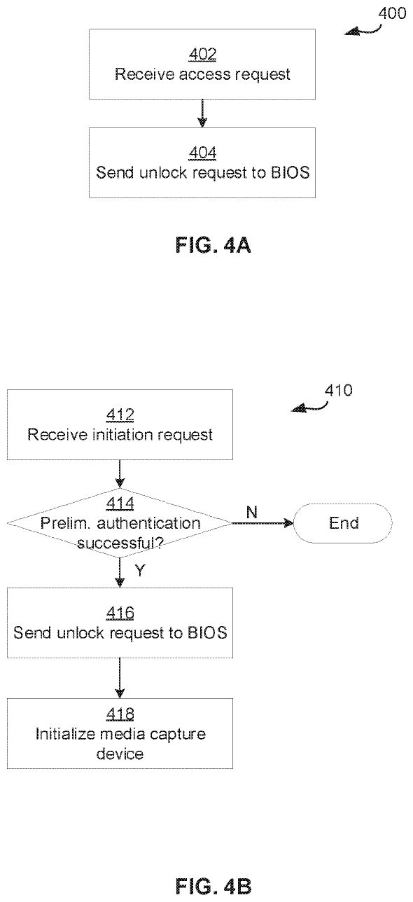

FIG. 4A depicts a flowchart of an example method 400 of processing a media capture device activation request. In particular, the method 400 is performed at the subject media capture device. The method 400 is described below in conjunction with its performance by the media capture device 202; in other examples, other suitable media capture devices may perform the method 400.

At block 402, the media capture device 202 receives an access request. The access request may be received, for example, from the processor 212 from execution of the media capture device management application 218, or from execution of another application, such as a video-conferencing application, requesting activation of the media capture device 202. In other examples, the access request may be received from the processor 212 upon detecting that the switch 208 is moved to the on position.

At block 404, in response to the access request, the media capture device 202 sends the unlock request to the BIOS 206.

FIG. 4B depicts a flowchart of another example method 410 of processing a media capture activation request. In particular, the method 410 is performed by a processor of a computing device. The method 410 is described below in conjunction with its performance by the processor 212 via execution of the instructions defined in the application 218; in other examples, other suitable processors or controllers may perform the method 410.

At block 412, the processor 212 receives an initiation request. The initiation request may be received, for example, from movement of the switch 208 to the on position. In other examples, the initiation request may be received from execution of another application, such as a video conferencing application, requesting activation of the media capture device 202.

At block 414, the processor 212 may perform a preliminary authentication. In particular, the processor 212 may first obtain a preliminary authentication input. The preliminary authentication input may be obtained, for example, by prompting an operator of the computing device 200 at the input/output device 216, such as via an audio or visual indicator. The preliminary authentication input may be a password, a personal identification number (PIN), a biometric, such as a fingerprint, or the like. Generally, when the media capture device 202 is deactivated, the preliminary authentication input will be a value which can be input with the input/output device 216 and without utilizing the media capture device 202 (e.g., a password rather than a facial recognition scan). The processor 212 is to compare the preliminary authentication input against a preliminary authentication parameter stored in association with the application 218 to match or substantially map the preliminary authentication input to the preliminary authentication parameter.

In response to a successful preliminary authentication verification, the method 410 proceeds to block 416. If the preliminary authentication is unsuccessful, the method 410 ends, and the media capture device 202 remains inactivated. In some examples, the method 410 may proceed directly from block 412 to block 416, skipping the preliminary authentication at block 414.

At block 416, in response to the initiation request, the processor 212 sends the unlock request to the BIOS 206. In some examples, the unlock request may include an authentication input to be verified by the BIOS 206. For example, prior to generating the unlock request, the processor 212 may request, at the input/output device 216, an authentication input from an operator of the computing device 200. In another example, the authentication input may be the same as the preliminary authentication input, to be verified again against the authentication parameter stored in the BIOS 206.

At block 418, in response to a successful authentication of the unlock request by the BIOS 206, the processor 212 is to control an operating system device manager to initialize the media capture device 202 to allow the media capture device 202 to capture media. That is, after successful authentication of the unlock request, the processor 212 may receive a response from the BIOS 206 indicating said successful authentication. Accordingly, the processor 212 may initialize the media capture device 202 to carry out the software-level initialization and complete the activation of the media capture device 202.

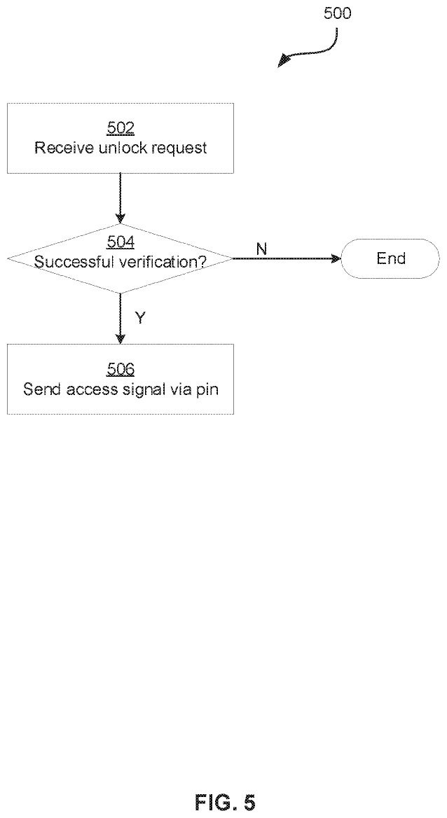

FIG. 5 depicts a flowchart of an example method 500 of processing an unlock request received at a basic input/output system. In particular, the method 500 is described below in conjunction with its performance by the BIOS 206; in other examples, other suitable basic input/output systems may perform the method 500.

At block 502, the BIOS 206 receives an unlock request. The unlock request may be received, for example, from the media capture device 202 or from the processor 212, via the execution of one or both of the methods 400 and 410.

At block 504, the BIOS 206 verifies an authentication input. In particular, the BIOS 206 may first obtain an authentication input. For example, the BIOS 206 may request the authentication input by prompting an operator of the computing device 200 at the input/output device 216, such as via an audio or visual indicator. In other examples, the authentication input may be extracted from the unlock request, such as when the authentication input was previously obtained. The authentication input may be a password, a personal identification number (PIN), a biometric, such as a fingerprint, or the like. Generally, when the media capture device 202 is deactivated, the authentication input will be a value which can be input with the input/output device 216 and without utilizing the media capture device 202 (e.g., a password rather than a facial recognition scan). The BIOS 206 is to compare the authentication input against an authentication parameter stored at the BIOS 206, for example in a BIOS variable to match or substantially map the authentication input to the authentication parameter.

In response to a successful verification of the authentication input, the method 500 proceeds to block 506. If verification of the authentication input is unsuccessful, the method 500 ends, and the media capture device 202 remains inactivated.

At block 506, in response to a successful verification, the BIOS 206 sends an unlock signal to unlock the media capture device 202 via the pin 204. For example, to unlock the media capture device 202, the BIOS 206 may provide power to the media capture device 202 via the pin 204, the power acting as the unlock signal to unlock the media capture device 202. In the single-layered activation process, unlocking the media capture device 202 by the BIOS 206 completes activation of the media capture device 202.

In the double-layered activation process, after unlocking the media capture device 202, in response to a successful verification, the BIOS 206 may send a response to the processor 212 to perform a software-level initialization of the media capture device 202 to complete the activation of the media capture device 202.

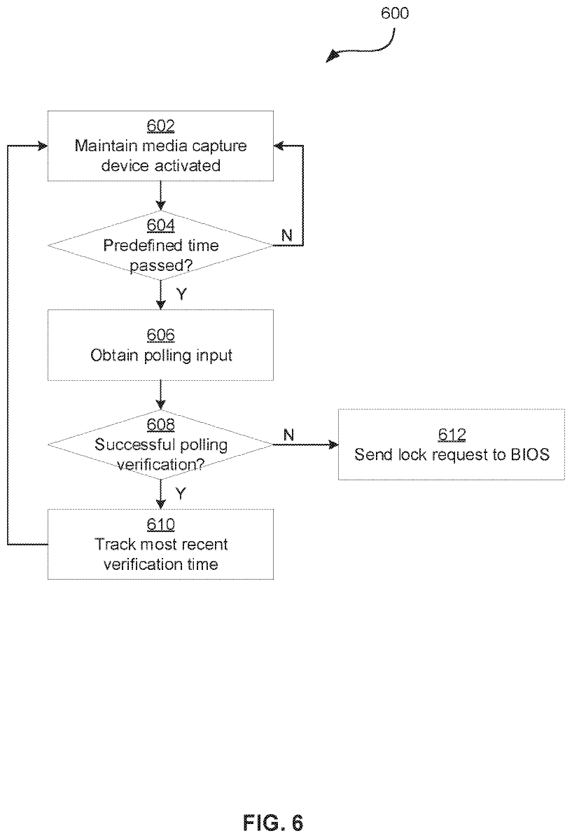

FIG. 6 depicts a flowchart of an example method 600 of polling when the media capture device is activated to ensure continued security. The method 600 is described in conjunction below with its performance by the processor 212 via execution of the instructions defined in the application 218; in other examples, other suitable processors or controllers may perform the method 600. For example, while the method 600 may be performed by the processor 212 for efficiency and reduced implementation complexity, the method 600 may alternately be performed by the BIOS 206 rather than the processor 212 for enhanced security while the media capture device 202 is activated.

At block 602, the media capture device 202 is maintained in its activated state.

At block 604, the processor 212 determines whether a predefined time has passed since a most recent verification. In particular, a most recent verification time may be retrieved from the memory 214, or from another storage medium associated with the application 218. The most recent verification time represents the time at which the most recent verification took place. For example, after a successful verification to unlock the media capture device at block 506, a timestamp associated with the successful verification may be stored as the most recent verification time. If, at block 604, a predefined threshold amount of time has passed since the most recent verification, the method 600 proceeds to block 606. If the predefined threshold amount of time has not passed since the most recent verification, the method 600 returns to block 602 to maintain the media capture device 202 activated.

At block 606, the processor 212 obtains a polling input. The polling input may be a biometric, such as a facial recognition scan, an iris or retina scan, a voice clip for voice recognition, or the like. Preferably, the polling input may be an input obtainable with little to no operator input, such as by utilizing the activated media capture device 202. In other examples, the polling input may be obtained, by prompting an operator of the computing device 200 at the input/output device 216, such as via an audio or visual indicator. Such a polling input may be, for example, a password, a PIN, a biometric, such as a fingerprint, or the like.

At block 608, the processor 212 compares the polling input to a polling parameter stored in association with the application 218 to match or substantially map the polling input to the polling parameter. In response to a successful polling verification, the method 600 proceeds to block 610.

At block 610, the processor 212 tracks the time of the successful polling verification completed at block 608. For example, the processor 212 may obtain a timestamp of the successful polling verification completed at block 608 and overwrite the stored most recent verification time. The processor 212 then returns to block 602 to maintain the media capture device 202 activated.

If, at block 608, the polling verification is unsuccessful, the method 600 proceeds to block 612. At block 612, in response to an unsuccessful polling verification, the processor 212 sends a lock request to the BIOS 206.

When a lock request is received, the BIOS 206 may send a stop command to the processor 212 to stop the media capture device 202 (e.g., via the operating system device manager) in the double-layered activation process, and remove the unlock signal (e.g., removing power) to the media capture device 202 via the pin 204 to lock the media capture device 202. In the single-layered activation process, the BIOS 206 may simply remove the unlock signal from the media capture device 202 via the pin 204 to lock the media capture device 202.

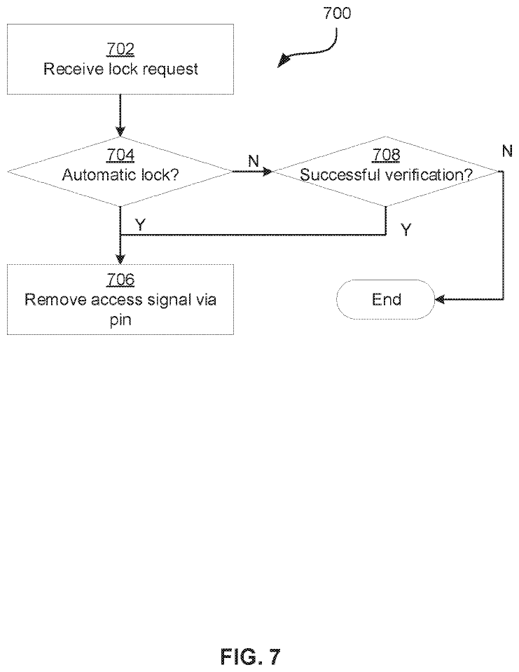

In other examples, the BIOS 206 may employ a similar verification of the lock request to authenticate the lock request. FIG. 7 depicts a flowchart of an example method 700 of processing a lock request. In particular, the method 700 is described below in conjunction with its performance by the BIOS 206; in other examples, other suitable systems or devices may perform the method 700.

At block 702, the BIOS 206 receives a lock request. The lock request may be received, for example, from the media capture device 202 or from the processor 212. The lock request may be generated, for example, when the switch 208 is moved to the off position. In other examples, the media capture device 202 may periodically check to determine whether it is in use; when the media capture device 202 has not been utilized for a threshold period of time, the media capture device 202 may generate a lock request to be sent to the BIOS 206.

At block 704, the BIOS 206 determines whether an automatic lock implementation is in place, or whether the lock request is to be verified prior to deactivating the media capture device 202.

If, at block 704, the BIOS 206 determines that an automatic lock procedure is in place, the method 700 proceeds to block 706. At block 706, the BIOS 206 removes the unlock signal to lock the media capture device 202 via the pin 204. For example, the BIOS 206 may remove power provided to the media capture device 202. In the single-layered activation process, locking of the media capture device 202 by the BIOS 206 completes deactivation of the media capture device 202. In the double-layered activation process, prior to removing the unlock signal from the media capture device 202, the BIOS 206 sends a stop command to the processor 212 to stop the media capture device 202, for example, via the operating system device manager. Subsequently, the BIOS 206 removes the unlock signal to lock the media capture device 202 and complete the deactivation of the media capture device 202.

If, at block 704, the BIOS 206 determines that the lock request is to be verified, the method 700 proceeds to block 708. At block 708, the BIOS 206 verifies an authentication input. In particular, the BIOS 206 may first obtain an authentication input. In other examples, the authentication input may be extracted from the lock request. The authentication input may be a facial recognition scan, an ins or retina scan, or the like. The BIOS 206 is to compare the authentication input against an authentication parameter stored at the BIOS 206, for example in a BIOS variable to match or substantially map the authentication input to the authentication parameter.

In response to a successful verification of the authentication input at block 708, the method 700 proceeds to block 706. If the verification of the authentication input is unsuccessful, the method 700 ends, and the media capture device 202 remains activated.

As described above, an example computing device includes a media capture device, a pin and a BIOS storing an authentication parameter. Upon receipt of an unlock request, the BIOS verifies an authentication input against the authentication parameter. Upon successful verification, the BIOS unlocks the media capture device via the pin, for example, by enabling power to the media capture device via the pin. By using the BIOS to authenticate, the media capture device may be less vulnerable to attacks.

The BIOS activation control of the media capture devices may be made more robust for cross-platform implementation by implementing generation of the unlock request in the media capture device firmware. In further examples, BIOS activation control may be combined with preliminary authentication, multi-layered activation, and periodic polling to securely manage the media capture device.

The scope of the claims should not be limited by the above examples, but should be given the broadest interpretation consistent with the description as a whole.

1. A computing device comprising:
a media capture device to capture media;
a pin coupled to the media capture device to communicate an unlock signal to the media capture device; and
a basic input/output system interconnected with the pin, wherein, to control activation of the media capture device, the basic input/output system is to:
store an authentication parameter;
receive, from the media capture device, an unlock request;
in response to the unlock request, verify an authentication input against the authentication parameter; and
in response to a successful verification, send the unlock signal to unlock the media capture device via the pin.

2. The computing device of claim 1, wherein the media capture device is to:
receive an access request to access the media capture device; and
in response to the access request, send the unlock request to the basic input/output system.

3. The computing device of claim 2, further comprising:
a memory; and
a processor interconnected with the memory and the media capture device, the processor to:
in response to an initiation request from an application of the computing device, send the access request to media capture device.

4. The computing device of claim 3, further comprising a switch coupled to the media capture device, the switch switchable between an on position and an off position, wherein the initiation request is generated when the switch is in the on position.

5. The computing device of claim 3, wherein the processor is further to:
in response to the initiation request, verify a preliminary authentication input; and
in response to a successful preliminary authentication verification, send the access request to the media capture device.

6. The computing device of claim 1, wherein, prior to verifying the authentication input, the basic input/output system is to request the authentication input.

7. The computing device of claim 1, wherein, to unlock the media capture device, the basic input/output system is to provide power to the media capture device via the pin.

8. The computing device of claim 1, wherein the basic input/output system is further to, when the media capture device is activated:
obtain a polling input;
verify the polling input against a polling parameter; and
in response to a successful polling verification, maintain activation of the media capture device.

9. A computing device comprising:
a media capture device to capture media;
a pin coupled to the media capture device to communicate an unlock signal to the media capture device;
a basic input/output system interconnected with the pin, the basic input/output system to:
receive an unlock request for a media capture device;
verify an authentication input associated with the unlock request against an authentication parameter; and
in response to a successful verification, unlock, via the pin, the media capture device to activate the media capture device; and
a processor to:
when the media capture device is activated, obtain a polling input;
verify the polling input against a polling parameter; and
in response to a successful polling verification, maintain activation of the media capture device.

10. The computing device of claim 9 wherein the processor is further to:
in response to receiving an initiation request, verify a preliminary authentication input; and
in response to a successful preliminary authentication verification, send the unlock request to the basic input/output system.

11. The computing device of claim 9, wherein the media capture device is to:
receive an access request; and
in response to the access request, send the unlock request to the basic input/output system.

12. The computing device of claim 9, wherein the processor is further to, in response to an unsuccessful polling verification, send a lock request to the basic input/output system.

13. A non-transitory machine-readable storage medium storing machine-readable instructions, when executed, cause a processor of a computing device to:
in response to receiving an initiation request at a media capture device, send an unlock request to a basic input/output system;
in response to a successful authentication of the unlock request by the basic input/output system, control an operating system device manager to initialize the media capture device to allow the media capture device to capture media;
when the media capture device is activated, track a time since a most recent verification;
after a predefined time since the most recent verification, verify a polling input to maintain the media capture device activated.

14. The non-transitory machine-readable storage medium of claim 13, wherein, when executed, the instructions further cause the processor to:
verify a preliminary authentication input;
in response to a successful preliminary authentication, generate the unlock request, including an authentication input; and
send the unlock request to the basic input/output system.

15. The non-transitory machine-readable storage medium of claim 13, wherein the instructions, when executed, further cause the processor to, in response to an unsuccessful polling verification, send a lock request to the basic input/output system.
